(19) United States
(12) Patent Application Publication
(10) Pub. No.: US 2015/0027747 A1
(43) Pub. Date: Jan. 29, 2015

(54) FOAM INSULATED CONDUCTORS

(71) Applicant: E I DU PONT DE NEMOURS AND COMPANY, Wilmington, DE (US)

(72) Inventor: Gary Thuot, Hockessin, DE (US)

(73) Assignee: E I DU PONT DE NEMOURS AND COMPANY, Wilmington, DE (US)

(21) Appl. No.: 14/373,178

(22) PCT Filed: Jan. 25, 2013
(86) PCT No.: PCT/US13/23038

§ 371 Date: Jul. 18, 2014

Related U.S. Application Data
(60) Provisional application No. 61/591,399, filed on Jan. 27, 2012.

(51) Int. Cl. H01B 3/40; H01B 1/02; H01B 3/00

(52) U.S. Cl. CPC H01B 3/40; H01B 3/002; H01B 1/026
USPC 174/110 F

(57) ABSTRACT

An electrical cable comprising a conductor and a foamed insulation surrounding the conductor is disclosed. The foamed insulation has a uniform void size and an improved adhesion to the conductor. Electrical cables having a conductor thickness less than 22 mil are also disclosed.

### FIELD OF THE INVENTION

The present invention relates to foam insulated conductors. More particularly, the present invention relates to foam insulated micro-cables, such as micro-coaxial cables and other small-scale electrical cables.

### BACKGROUND OF THE INVENTION

As electronic devices become increasingly smaller, there is a growing need for electrical cables for those miniaturized devices. Cellular telephones, ultra-light laptop computers, and other portable devices (GPS navigation systems, tablet computers, portable game devices, etc.) are continuously designed to be smaller, lighter, and more portable. With the continued trend to smaller devices, new electrical conductors must be developed to keep pace.

Smaller electrical cables may also be useful for devices requiring greater data throughput. For example, as the resolution of sensors or detectors increase, so does the need for capacity to transfer the increased amount of data. Using smaller electrical cables decreases the amount of materials required and also allows for bundling of multiple cables to create a single cable. In some applications, hundreds of individual electrical cables may be bundled into one flexible cable.

As conductors get smaller, the insulation surrounding the conductor has a more significant impact on the electrical properties of the cable, such as signal attenuation and cable return loss. Smaller conductors generally require thinner-walled insulation. Thus, there may be a need to center the conductor within the insulation with more precision than required for larger conductors.

For foamed insulation, large variation in the void size can substantially alter the dielectric properties of the cable over its length. An area in the insulation having a large void may exhibit a lower localized dielectric constant that an area having multiple smaller voids. Such a difference may render a cable unsuitable for the desired application.

As electrical cables get smaller, problems may also arise in the adhesion between the conductor and the insulation. The small contact area between the conductor and insulation may exacerbate low adhesion.

It is thus desirable to have an insulated electrical cable having a small conductor. It is also desirable to provide a foamed insulation for electrical cables having a small wall thickness that provides suitable electrical properties for electrical cables with small conductors. It is also desirable to provide a good adhesion between such small conductors and foamed insulation.

### SUMMARY OF THE INVENTION

Briefly stated, and in accordance with one aspect of the present invention, there is provided an electrical cable comprising:
a conductor; and
a foamed insulation surrounding said conductor,
wherein said conductor has a thickness of no more than about 22 mil.

In accordance with another aspect of the present invention, there is provided a foamed insulation for an electrical cable, wherein the foamed insulation comprises a foamed fluoropolymer having a plurality of voids, wherein the foamed insulation has a thickness ranging from about 1 mil to about 15 mil, wherein the voids have an average size ranging from about 0.1 mil to about 1 mil.

The foamed insulation of the present invention may comprise a foamed fluoropolymer.

### BRIEF DESCRIPTION OF THE DRAWINGS

The invention will be more fully understood from the following detailed description, taken in connection with the accompanying drawings, in which:

FIG. 1 is a magnified picture showing a cross-section of a foamed insulation comprising a foamed perfluoroalkoxy copolymer.

FIG. 2 is a magnified picture of a foamed insulation comprising a fluorinated ethylene propylene copolymer.

While the present invention will be described in connection with a preferred embodiment thereof, it will be understood that it is not intended to limit the invention to that embodiment. On the contrary, it is intended to cover all alternatives, modifications, and equivalents as may be included within the spirit and scope of the invention as defined by the appended claims.

### DETAILED DESCRIPTION OF THE INVENTION

Before addressing details of embodiments below, the following terms are defined or clarified.

The terms “perfluoroalkoxy copolymer,” “PFA copolymer,” and “PFA” are used herein to refer to copolymers of tetrafluoroethylene (“TFE”) and perfluoro(alkyl vinyl ether) (“PAVE”). The PFA copolymer may conform to the ASTM D3307-10 standard. The PFA copolymer may comprise perfluoro(methyl vinyl ether) (“PMVE”), perfluoro(ethyl vinyl ether) (“PEVE”), perfluoro(propyl vinyl ether) (“PPVE”), perfluoro(butyl vinyl ether) (“PBVE”), or combinations thereof.

The term “fluorinated ethylene propylene,” “FEP copolymer,” and “FEP” are used herein to refer to copolymers of hexafluoropropylene (“HFP”) and TFE. Examples of FEP copolymers include those falling within the specifications of ASTM D2116-07.

The term “melt flow rate” or “MFR” is the melt flow rate of a polymer or copolymer as measured according to ASTM D-1238 using a 5 kg weight on the molten polymer or copolymer and at a temperature of 372° C. as set forth in ASTM D-3307-93 for PFA copolymers and ASTM D-2116-91a for FEP copolymers.

As used herein, the term “void size” and variations thereof refer to the maximum dimension of a void. For example, the void size of a spherical void would be the diameter of the void, and the void size of an oblate spheroid would be the length of the major axis. The term “average void size” is a mathematical average of the void size of each void.

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the present invention, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

In accordance with at least one embodiment of the present invention, an electrical cable comprises a conductor and a foamed insulation surrounding the conductor. The conductor may comprise any electrically conductive material known in the art, such as, for example, copper and copper alloys, steel and coated steel (e.g., copper covered carbon steel), aluminum and aluminum alloys, silver, etc. One skilled in the art would understand that the conductive material may be selected based on the desired electrical properties of the electrical cable, the desired mechanical properties of the electrical cable, the application or location in which the electrical cable will be used, as well as other considerations necessary when determining a suitable conductive material.

In at least one embodiment the conductor is 24 AWG or smaller (about 22 mil or less). In a further embodiment the conductor is 32 AWG or smaller (about 8 mil or less). In a still further embodiment the conductor is 36 AWG or smaller (about 5 mil or less). In at least one further embodiment, the conductor is 38 AWG or smaller (about 4 mil or less). In other embodiments, the conductor is 40 AWG or smaller (about 3 mil or less), 42 AWG or smaller (about 2.5 mil or less), 44 AWG or smaller (about 2 mil or less), 46 AWG or smaller (about 1.5 mil or less), or 48 AWG or smaller (about 1.2 mil or less).

In at least one embodiment, the conductor has a thickness ranging from about 38 AWG to about 48 AWG. In other embodiments, the conductor may have a thickness ranging from about 40 AWG to about 46 AWG.

The term “thickness” refers to the maximum width of the conductor. The conductor used in accordance with the present disclosure may have a circular cross-section, a square cross-section, an elliptical cross-section, a triangular cross-section, or any other polygonal cross-sectional geometry. One of ordinary skill in the art would recognize that the geometry of the conductor may be selected based on the desired application of the electrical cable or the desired electrical properties of the electrical cable.

In at least one embodiment, the foamed insulation may comprise a fluoropolymer. For example, the fluoropolymer may comprise a PFA copolymer. In a further embodiment the foamed insulation consists essentially of PFA copolymer, According to at least one embodiment, the PAVE component of the PFA copolymer is chosen from PMVE, PEVE, PPVE, and PBVE copolymers. In at least one embodiment, the PFA copolymer comprises PPVE.

In accordance with at least one embodiment of the present invention, the PFA copolymer has a melt flow rate (“MFR”) of at least about 35 g/10 min. In other embodiments, the PFA copolymer has a MFR of at least about 40 g/10 min. In a further embodiment, the PFA copolymer has a MFR of about 42 g/10 min.

In some embodiments, the MFR of the PFA copolymer may range from about 35 g/10 min to about 50 g/10 min, such as, from about 38 g/10 min to about 47 g/10 min, or from about 40 g/10 min to about 44 g/10 min.

The foamed insulation in accordance with embodiments of the present invention may contain voids having an average size ranging from about 0.1 mil to about 1 mil. In other embodiments, the voids may have an average size ranging from about 0.25 mil to about 0.5 mil. In an embodiment of the present invention the insulation is a closed cell foam.

The voids in the foamed insulation may exhibit a narrow range of sizes. For example, at least about 90% of the voids in the foamed insulation may have a size ranging from about 0.25 mil to about 0.5 mil. In other embodiments, at least 95% of the voids have a size ranging from 0.25 mil to about 0.5 mil. In other words, some embodiments may have less than 5% or less than 10% of the voids outside of the range from 0.25 mil to about 0.5 mil.

The consistency of the void size may also be described as a deviation from the average size. For example, the foamed insulation may have substantially no voids that vary from the average size of the voids by more 2 standard deviations. In other embodiments, substantially all of the voids vary from the average size of the voids by less 1 standard deviation. As used herein, “substantially all of the voids” means at least 98% of the total volume occupied by the voids or the total area occupied by the voids in a cross-section of the insulation.

By foamed insulation it is meant that the foam has a void content ranging from about 10% to about 55%. In other embodiments, the void content may range from about 20% to about 40% or from about 40% to about 50%.

The foamed insulation surrounding the conductor may have a wall thickness ranging from about 1 mil to about 15 mil. In at least one embodiment, the wall thickness ranges from about 2 mil to about 10 mil. One of ordinary skill in the art would recognize that the wall thickness of the foamed insulation can be determined based on the desired electrical properties of the electrical cable (e.g., the desired impedance), the dielectric constant of the insulating material, the radius of the conductor and/or the radius of an outer conductor if present, etc.

The electrical cable of the present disclosure may further comprise a polymer layer on the outer surface of the foamed insulation. In at least one embodiment, the polymer layer comprises a solid (i.e., unfoamed) layer.

The electrical cable may be in the form of a coaxial cable, wherein the conductor and the foamed insulation are further surrounded by a shielding layer and an outer jacket.

The electrical cable may also be in the form of a twisted pair, wherein the electrical cable comprises two conductors, each of which is surrounding by a foamed insulation and the two insulated conductors are then twisted around one another.

The electrical cable of the present disclosure may also be used in a bundled cable. The bundled cable may comprise a plurality of foam insulated conductors, a plurality of twisted pairs, or a plurality of coaxial cables.

In at least one embodiment, the foamed insulation may be in the form of a tube. The inner diameter of the tube may be about 22 mil or less. Many aspects and embodiments have been described above and are merely exemplary and not limiting. After reading this specification, skilled artisans appreciate that other aspects and embodiments are possible without departing from the scope of the invention.

Other features and benefits of any one or more of the embodiments will be apparent from the following detailed description, and from the claims.

### EXAMPLES

The concepts described herein will be further described in the following examples, which do not limit the scope of the invention described in the claims.

### Example 1

In Example 1, an electrical cable was made using a solid, single-strand 24 AWG copper conductor. The conductor was surrounded with a foamed insulation comprising a PFA copolymer having a MFR of 42 g/10 min. The PFA copolymer comprised TFE and about 4.5% by weight PPVE (DuPont™ Teflon® PFA 416HP Fluoropolymer resin, available from DuPont Company).

The insulated wire was formed as follows. A foam nucleating package comprising boron nitride (91.1±0.5 wt %), calcium tetraborate (2.5±0.2 wt %) and Zonyl® BAS (6.4±0.2 wt %) was used. This foam nucleating package was compounded into Teflon® PFA 416 fluoropolymer (manufactured E.I. du Pont de Nemours & Co., Wilmington, Del.), a perfluoropolymer having a melt flow rate (MFR) 42 g/10 min. to form a master batch having a boron nitride content of approximately 4 wt % of the resultant composition.

Pellets were formed via compounding operations performed on a Kombi-plast extruder consisting of a 28 mm twin-screw extruder and a 38 mm single screw extruder. The master batch pellets and pellets of the base fluoropolymer (Teflon® PFA 416) were dry blended at a ratio of about 9.5:0.5 to form a foamable thermoplastic composition which was subsequently fed to a Nokia-Maillefer 45 mm extrusion wire-line to extrude insulation onto 24 AWG (0.57 mm) solid copper conductor. The extruder had a length/diameter ratio of 30:1 and was equipped with a mixing screw in order to provide uniform temperature and dispersion of nitrogen into the melt.

The foamed thermoplastic composition material was extruded onto wire at a speed of 300 ft/min (91 m/min) to produce an insulation 0.36 mm in thickness having void content of 30%. Die and guider tip combination that yielded a draw down ratio (cross-sectional area of the die area/cross-sectional area of the finished extrudate) of 16:1 were utilized.

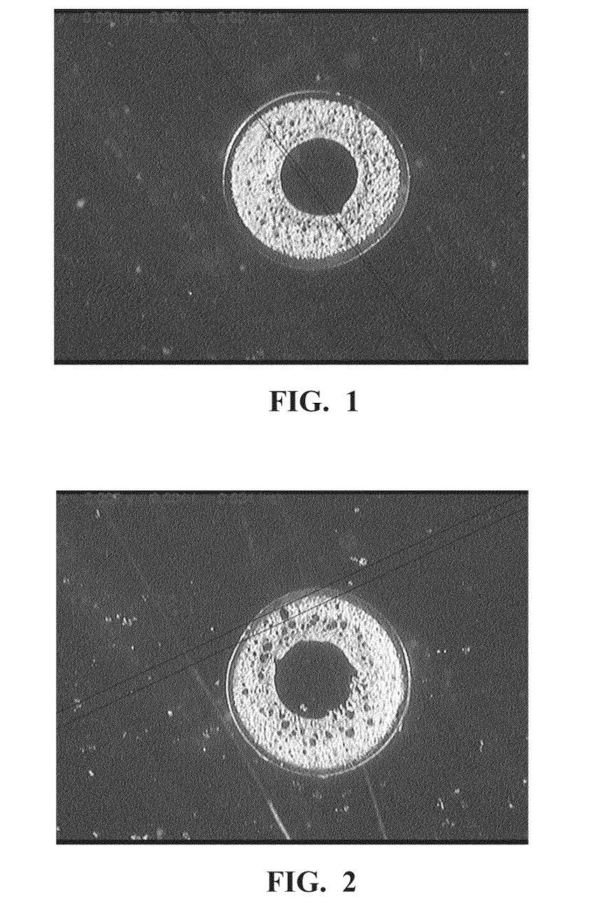

The foamed insulation was observed under high magnification as shown in FIG. 1. As can be seen, the foamed insulation of Example 1 comprised uniformly sized voids.

25 samples of the electrical cable of Example 1 were tested to determine the peak load. The average peak load, or strip force, observed for Example 1 was 1.49 lbf, with a standard deviation of 0.13 lbf, measured according to ASTM D-3032-10. As can be seen, the electrical cable of Example 1 also demonstrates the superior adhesion between the conductor and foamed insulation.

### Comparative Example 1

In Comparative Example 1, an electrical cable was made using a solid, single-strand copper conductor, which was surrounded by a foamed insulation. The dimensions of the conductor and insulation were essentially identical to those of Example 1. The foamed insulation of Comparative Example 1 was made using Teflon® FFR 770 fluoropolymer resin available from DuPont. The same nucleant package used in Example 1 was used to produce the foamed insulation for this Comparative Example 1. Teflon® FFR 770 is a FEP fluoropolymer having a MFR of 30 g/10 min.

The foamed insulation of Comparative Example 1 was observed under magnification as shown in FIG. 2. As can be seen, the foamed insulation of Comparative Example 1 had void sizes that deviated more greatly than the voids of Example 1, and included much larger voids.

25 samples of the electrical cable of Comparative Example 1 were tested to determine the peak load. The average peak load observed for Comparative Example 1 was 1.17 lbf, with a standard deviation of 0.21 lbf.

Thus, the electrical cable of Example 1 exhibited a significantly higher peak stress and peak load than Comparative Example 1, while also exhibiting a lower standard deviation.

1. An electrical cable comprising:
a conductor; and
a foamed insulation surrounding said conductor,
wherein said conductor has a thickness of no more than about 22 mil.

2. The cable of claim 1, wherein said conductor has a thickness of no more than about 8 mil.

3. (canceled)

4. (canceled)

5. The cable of claim 1, wherein said foamed insulation comprises a fluoropolymer.

6. The cable of claim 5, wherein said fluoropolymer comprises a perfluoroalkoxy copolymer.

7. The cable of claim 6, wherein said perfluoroalkoxy copolymer has a melt flow rate of at least about 35 g/10 min.

8. (canceled)

9. The cable of claim 6, wherein said perfluoroalkoxy copolymer has a melt flow rate ranging from about 35 g/10 min to about 50 g/10 min

10. (canceled)

11. (canceled)

12. The cable of claim 1, wherein said foamed insulation comprises a plurality of voids, wherein the voids have an average size ranging from about 0.1 mil to about 1 mil.

13. (canceled)

14. (canceled)

15. (canceled)

16. The cable of claim 12, wherein said voids have a size that varies by no more than 2 standard deviations.

17. (canceled)

18. The cable of claim 1, wherein said foamed insulation has a wall thickness ranging from about 1 mil to about 15 mil.

19. (canceled)

20. The cable of claim 12, wherein said foamed insulation has a void density ranging from about 25% to about 75%.

21. (canceled)

22. (canceled)

23. The cable of claim 1, further comprising a solid polymer layer on the outer surface of the foamed insulation.

24. The cable of claim 1, wherein the cable is a coaxial cable.

25. A foamed insulation for an electrical cable, wherein the foamed insulation comprises a foamed fluoropolymer having a plurality of voids, wherein the foamed insulation has a thickness ranging from about 1 mil to about 15 mil, wherein the voids have an average size ranging from about 0.1 mil to about 1 mil.

26. The insulation of claim 25, wherein said voids have a size that varies by no more 2 standard deviations.

27. The insulation of claim 25, wherein said foamed insulation has a void density ranging from about 25% to about 75%.

28. The insulation of claim 25, wherein said fluoropolymer comprises a perfluoroalkoxy copolymer

29. The insulation of claim 25, wherein said perfluoroalkoxy copolymer has a melt flow rate ranging from about 35 g/10 min to about 50 g/10 min

30. The insulation of claim 25, wherein said insulation is in the form of a tube wherein the inner diameter of the insulation is no greater than about 22 mil.

31. (canceled)
